(19) United States
(12) Patent Application Publication
(10) Pub. No.: US 2025/0273759 A1
(43) Pub. Date: Aug. 28, 2025

(54) ACTIVE MATERIAL SEPARATION DEVICE AND ACTIVE MATERIAL SEPARATION METHOD

(71) Applicant: HONDA MOTOR CO., LTD., Tokyo (JP)

(72) Inventors: Masaaki Fujita, Tokyo (JP); Masafumi Saito, Tokyo (JP); Kiyotaka Isobe, Tokyo (JP)

(21) Appl. No.: 19/056,800

(22) Filed: Feb. 19, 2025

(30) Foreign Application Priority Data
Feb. 27, 2024 (JP) 2024-027710

(51) Int. Cl. H01M 10/54; H01M 6/52

(52) U.S. Cl. CPC H01M 10/54; H01M 6/52

(57) ABSTRACT

An active material separation device includes a container, a battery support part, and an injection nozzle. A liquid is stored in the container. The battery support part supports a battery member disposed in the container. The injection nozzle injects a high pressure liquid with respect to an active material separation surface of the battery member immersed in a liquid in the container. The injection nozzle is disposed at a position where a liquid injection part configured to inject a high pressure liquid is immersed in the liquid in the container.

### CROSS-REFERENCE TO RELATED APPLICATION

Priority is claimed on Japanese Patent Application No. 2024-027710, filed Feb. 27, 2024, the content of which is incorporated herein by reference.

### BACKGROUND OF THE INVENTION

### Field of the Invention

The present invention relates to an active material separation device and an active material separation method, which separate an active material from a battery member.

### Description of Related Art

In light of climate-related disasters and the need to reduce CO₂ emissions, there is growing interest in electric vehicles, and the demand for batteries installed in these vehicles is also increasing. In this situation, research into the recycling of battery materials is underway. For example, research is being conducted focusing on aspects such as highly efficient recovery of active materials used in electrodes and cost reduction of the recovery process.

An active material separation device configured to separate an active material from a discarded battery has been proposed (for example, see Japanese Unexamined Patent Application, First Publication No. 2023-150114, and Japanese Unexamined Patent Application, First Publication No. 2023-150119).

The active material separation device disclosed in Japanese Unexamined Patent Application, First Publication No. 2023-150114, and Japanese Unexamined Patent Application, First Publication No. 2023-150119 is configured to inject a high pressure liquid to an outer surface of a battery member and separate an active material from the battery member using a jet stream of the liquid.

The separation device includes a container in which a liquid is stored, a base member (battery support part) configured to support a battery member in the container, and an injection nozzle configured to inject a high pressure liquid from above a liquid surface with respect to an outer surface of the battery member immersed in the liquid. When the active material is separated from the battery member, the battery member is installed on a base member such that an active material separation surface (separation target surface) of the battery member faces above vertically, and in this state, the liquid is introduced into the container and the battery member is disposed under a liquid surface of the liquid. After that, the high pressure liquid is injected toward the active material separation surface by the injection nozzle from above the liquid surface in the container.

Here, the high pressure liquid injected from the injection nozzle collides with the liquid surface in the container, dispersing an injection pressure to the surroundings. Accordingly, this prevents the injection pressure from concentrating at one point on the outer surface of the battery member. In addition, at this time, since the battery member is positioned under the liquid surface of the liquid, the active material separated from the outer surface of the battery member is prevented from scattering upward.

### SUMMARY OF THE INVENTION

In the above-mentioned separation device in the related art, the high pressure liquid is injected from the injection nozzle toward the liquid surface under which the battery member is immersed. For this reason, the high pressure liquid injected from the injection nozzle collides with the water surface, at which the energy of the liquid at this time is greatly attenuated. This means unnecessary energy loss of the high pressure liquid, and improvement is desirable from the viewpoint of effective energy utilization.

In addition, the above-mentioned separation device in the related art separates the active material from the battery member using the jet stream of the liquid itself, so the range in which the active material on the battery member can be separated is limited to the range directly hit by the jet stream. For this reason, in order to separate the active material from the entire area of the battery member, the base member that supports the battery member must be moved frequently and in small intervals within the container. This is not desirable from the viewpoint of efficient separation processing of the active material from the battery member, and the development of a more efficient separation technique is desired.

In addition, by increasing the injection pressure of the liquid injected from the injection nozzle, the range in which the active material can be separated can be expanded. However, in this case, the pressure of the jet stream of the liquid hitting the outer surface of the battery member increases, making the substrate of the battery member more likely to deform. Then, if the deformation of the substrate of the battery member becomes too large, the subsequent smooth separation of the active material will be hindered.

An aspect of the present invention is directed to providing an active material separation device, and an active material separation method that are capable of efficiently separating an active material from a battery member without applying excessive stress by a jet stream of a liquid to the battery member.

An active material separation device and an active material separation method of the present invention employ the following configuration in order to solve the above-mentioned problems.

That is, an active material separation device according to an aspect of the present invention is an active material separation device configured to separate an active material from a battery member (for example, a battery member (70) in an embodiment) containing the active material, the active material separation device including: a container (for example, a container (10) in the embodiment) in which a liquid (for example, a liquid (22) in the embodiment) is stored; a battery support part (for example, a battery support part (50) in the embodiment) that is disposed in the container and that is configured to support the battery member; and an injection nozzle (for example, an injection nozzle (20) in the embodiment) configured to inject a high pressure liquid with respect to an active material separation surface (for example, an active material separation surface (70a) in the embodiment) of the battery member immersed in the liquid in the container, the injection nozzle being disposed at a position where a liquid injection part (for example, a liquid injection part (20a) in the embodiment) configured to inject the high pressure liquid is immersed in the liquid in the container.

In the separation device of the aspect, the liquid injection part of the injection nozzle is immersed in the liquid in the container. For this reason, when the high pressure liquid is injected from the liquid injection part, the liquid in the container around the jet stream becomes under low pressure, which creates fine air bubbles. Accordingly, a bubble cloud is generated around the jet stream of the liquid, and the active material separation surface of the battery member is exposed to the bubble cloud. As a result, the active material on the active material separation surface is efficiently separated from the battery member due to exposure to a fine bubble cloud.

In the case of the separation device of the aspect, since the high pressure liquid injected from the injection nozzle does not collide with the liquid surface inside the container, unnecessary energy loss is suppressed. In addition, since the bubble cloud occurs over a wide range around the jet stream of the liquid, the bubble cloud to which the active material separation surface is exposed exerts a separation effect over a wide range on the active material separation surface at once. For this reason, when the separation device of the aspect is employed, the active material can be efficiently separated from the battery member.

Further, in the separation device of the aspect, the active material is separated from the battery member by exposing the active material separation surface to a fine bubble cloud, which can suppress deformation of the substrate of the battery member caused by direct collision of the high pressure liquid with the battery member.

The battery support part is desirable to support the battery member such that the active material separation surface has a tilt angle with respect to a virtual plane (in the embodiment, a virtual plane v) perpendicular to an injection direction of the high pressure liquid.

In this case, the bubble cloud generated by the injection of high pressure liquid from the injection nozzle hits a wide range on the active material separation surface, which makes the separation of the active material more efficient. In addition, even when the high pressure liquid injected from the injection nozzle directly collides with the battery member, the impact on the core material of the battery member can be mitigated because the active material separation surface is tilted with respect to the liquid injection direction.

A tilt angle of the battery support part with respect to the virtual plane may be adjustable.

In this case, the posture of the battery member can be adjusted to the optimum tilt angle for each electrode member, enabling more efficient separation of the active material.

The battery support part may support the battery member such that the tilt angle with respect to the virtual plane is 90°.

In this case, it is possible to efficiently direct only the bubble cloud generated around the jet stream of the high pressure liquid onto the active material separation surface. At this time, even if the injection pressure of the liquid injected from the injection nozzle is increased, it becomes difficult for the jet stream of the liquid to directly hit the battery member. Accordingly, when the configuration is employed, this enables efficient separation of the active material by the bubble cloud while suppressing deformation of the substrate of the battery member.

The battery support part may support a plurality of battery members, and the plurality of battery members may be arranged such that each of the active material separation surfaces is disposed around a jet stream of the high pressure liquid.

In this case, it becomes possible to simultaneously expose the active material separation surfaces of the plurality of battery members to the bubble cloud generated around the jet stream of the liquid. Accordingly, when the configuration is employed, the active material can be efficiently separated from the plurality of battery members.

The battery support part may support a pair of battery members, and the pair of battery members may be arranged such that the active material separation surfaces face each other while having the jet stream of the high pressure liquid between the pair of battery members.

In this case, even if the area of the active material separation surface of each battery member is large, it is possible to bring the active material separation surfaces of the pair of battery members sufficiently close to the bubble cloud generated by the liquid injection.

The battery support part may be movable in a horizontal direction and a vertical direction.

In this case, it is possible to adjust the position of the battery member so that the bubble cloud generated around the jet stream of the liquid hits the appropriate location on the battery member.

In addition, an active material separation method according to an aspect of the present invention is an active material separation method of separating an active material from a battery member containing the active material, the active material separation method including: injecting a high pressure liquid in a liquid with respect to the battery member; and separating the active material using a bubble cloud (for example, a bubble cloud (65) in the embodiment) generated around a jet stream of the high pressure liquid.

When the active material separation method of the aspect is employed, the bubble cloud, which is a gathering of fine air bubbles, makes it possible to efficiently separate the active material from the battery member. In addition, in this method, the active material is separated from the battery member by the bubble cloud generated around the liquid jet stream, making it possible to efficiently separate the active material from a wide range on the battery member. Further, when the method is employed, it is also possible to suppress deformation of the substrate of the battery member caused by the jet stream of the high pressure liquid directly hitting the battery member.

According to the aspect of the present invention, it is possible to efficiently separate the active material from the battery member without applying excessive stress by the jet stream of the liquid to the battery member.

### BRIEF DESCRIPTION OF THE DRAWINGS

FIG. 1 is a longitudinal cross-sectional view showing a schematic configuration of an active material separation device of a first embodiment.

FIG. 2 is a longitudinal cross-sectional view showing another usage example of the active material separation device of the first embodiment.

FIG. 3 is a longitudinal cross-sectional view showing still another usage example of the active material separation device of the first embodiment.

FIG. 4 is a longitudinal cross-sectional view of yet another usage example of the active material separation device of the first embodiment.

FIG. 5 is a longitudinal cross-sectional view of an active material separation device of the second embodiment.

### DETAILED DESCRIPTION OF THE INVENTION

Hereinafter, each embodiment of the present invention will be described with reference to the accompanying drawings. In the specification and the drawings, components having substantially the same functional configurations are designated by the same reference numerals, and overlapping description will be omitted.

### First Embodiment

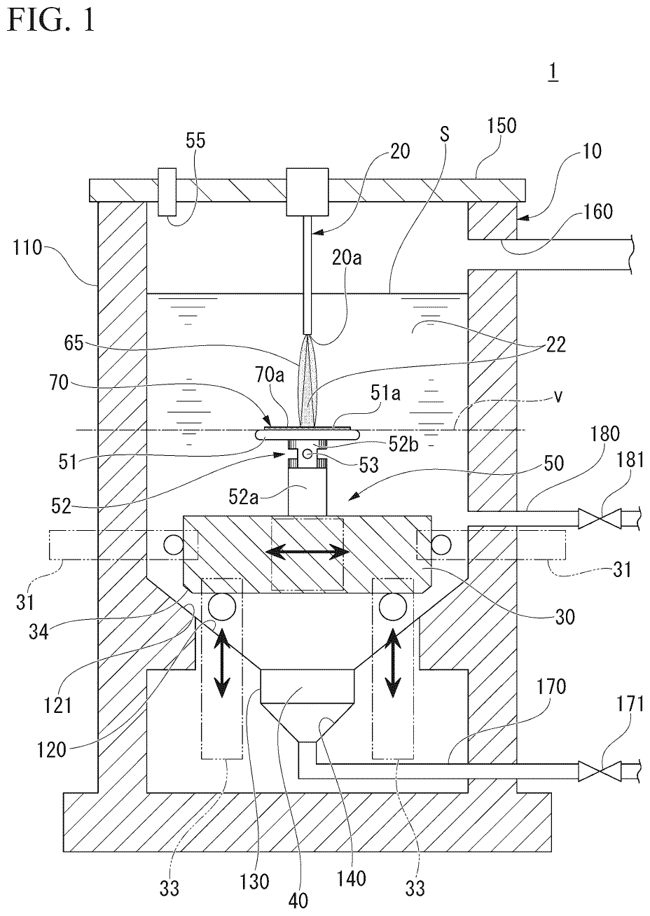

FIG. 1 is a longitudinal cross-sectional view showing a schematic configuration of an active material separation device 1 (hereinafter, simply referred to as “the separation device 1”) of the embodiment.

The separation device 1 is a device configured to separate an active material from a battery member 70. The separation device 1 includes a container 10 in which a liquid 22 is stored, a battery support part 50 configured to support the battery member 70 in the container 10, an injection nozzle 20 configured to inject a high pressure liquid 22 to an active material separation surface 70a (separation target surface) of the battery member 70, and a controller (not shown) configured to control instruments inside and outside the container 10.

The container 10 has a body portion 110 having an internal space extending in a vertical direction, a first reduced diameter section 120 disposed in the body portion 110 and having a diameter reducing downward in a tapered shape, a collecting section 130 connected to the first reduced diameter section 120, a second reduced diameter section 140 connected to the collecting section 130 and having a diameter reducing downward in a tapered shape, and a lid 150 disposed on an upper portion of the body portion 110 and configured to cover an opening above the body portion 110. The first reduced diameter section 120 has a contact portion 121 having a shape corresponding to a shape of a lower surface edge portion 34 of a moving table 30, which will be described below, and provided on the side of an upper surface of the first reduced diameter section 120. In the collecting section 130, a collecting filter 40 corresponding to the shape of the collecting section is disposed.

In addition, the container 10 includes an exhaust port 160, a first waste liquid section 170, and a second waste liquid section 180.

The exhaust port 160 is provided to pass through a wall surface near above the body portion 110. The exhaust port 160 is disposed on the wall surface of the body portion 110 above a liquid surface S of the liquid 22 in the container 10. The exhaust port 160 discharges unwanted gas generated within the container 10 to the outside of the container 10.

The first waste liquid section 170 is a tubular member and is connected to a lower end of the second reduced diameter section 140 in the body portion 110. The liquid 22 in the container 10 flows downward together with the active material separated from the battery member 70. The active material is collected by the collecting filter 40, and the liquid 22 passes through the collecting filter 40 to be discharged to the outside of the container 10 through the first waste liquid section 170.

A first opening/closing valve 171 is provided in the first waste liquid section 170. In a state in which the first opening/closing valve 171 is closed, the liquid 22 is introduced into the container 10 from the injection nozzle 20 or the like. The liquid 22 is introduced into the container 10 until the liquid surface S is at a specified height higher than the upper surface of the battery member 70. Accordingly, the battery member 70 is immersed below the liquid surface of the liquid 22 inside the container 10.

The second waste liquid section 180 is a tubular member connected to the body portion 110 to come into communication with the inside of the body portion 110. The liquid 22 stored in the container 10 can be discharged to the outside of the container 10 through the second waste liquid section 180. Upon discharge of the liquid 22 from the inside of the container 10, a discharge speed of the liquid 22 can be increased by opening the first waste liquid section 170 and the second waste liquid section 180 simultaneously.

In addition, the second waste liquid section 180 is connected to a position of the body portion 110 higher than the first reduced diameter section 120. For this reason, the liquid 22 discharged from the second waste liquid section 180 contains a small amount of active material. Accordingly, in the container 10, the liquid 22 is discharged without any decrease in a recovery rate of the active material. In addition, a second opening/closing valve 181 is provided in the second waste liquid section 180. When the second opening/closing valve 181 is closed, a larger volume of liquid 22 can be stored in the container 10.

The injection nozzle 20 configured to inject the high pressure liquid 22 is attached to the lid 150 of the container 10. The injection nozzle 20 extends downward from the lid 150, and a liquid injection part 20a is provided on a lower end of the injection nozzle 20. The high pressure liquid 22 is injected downward vertically from the liquid injection part 20a. The liquid injection part 20a is disposed at a height position immersed in the liquid 22 in the container 10 when the active material is separated from the active material separation surface 70a of the battery member 70. That is, a tip portion of the liquid injection part 20a is disposed at a position lower than the liquid surface S of the liquid 22 stored in the container 10.

The liquid 22 injected from the injection nozzle 20 is a liquid reacted with a solid electrolyte material contained in the battery member 70. As the used liquid 22, for example, a protic polar solvent can be exemplified, and specifically, water, ethanol, methanol, acetone, or the like, can be exemplified.

The liquid 22 stored in the container 10 can be the same liquid as the liquid 22 injected from the injection nozzle 20. However, in this case, dissolved components of the battery member 70 are mixed with the liquid 22 stored in the container 10. The liquid 22 may be introduced into the container 10 through the injection nozzle 20, and the liquid 22 may be introduced from a separate introduction port (not shown) before injection of the liquid 22 from the injection nozzle 20 starts.

The battery support part 50 includes the moving table 30 movably held in the container 10 in a horizontal direction and a vertical direction, a fixed stand 51 configured to fix the battery member 70, and a tilt angle adjusting mechanism 52 configured to connect the fixed stand 51 onto the moving table 30 in an angle adjustable manner.

A basic posture of the moving table 30 is a posture in which an upper surface is horizontal. The tilt angle adjusting mechanism 52 includes, for example, a columnar stay 52a standing at a center of the upper surface of the moving table 30, a movable block 52b pivotably connected to an upper end portion of the stay 52a via a pivot shaft 53, and a lock portion (not shown) configured to fix a pivot angle of the movable block 52b with respect to the stay 52a. The pivot shaft 53 of the tilt angle adjusting mechanism 52 is a shaft extending in the horizontal direction. The fixed stand 51 is connected to the upper surface of the movable block 52b.

The fixed stand 51 has a substantially flat placing surface 51a and is provided on a side which separates away from the pivot shaft 53 while having the movable block 52b between the placing surface 51a and the pivot shaft 53. The battery member 70 is placed on the placing surface 51a, and in this state, the battery member 70 is fixed by an appropriate fixing means. In this case, when the placing surface 51a of the fixed stand 51 is horizontal, it is desirable to set the active material separation surface 70a of the battery member 70 to face vertically upward.

Further, the active material separation surface 70a of the battery member 70 refers to the outer surface portion of the battery member 70 that is subjected to separation processing when the separation processing of the active material from the battery member 70 is performed. The active material separation surface 70a can be appropriately changed depending on how the battery member 70 is fixed to the fixed stand 51. When the battery member 70 has a plate-like shape as shown in FIG. 1, for example, it is desirable to set the surface with the largest area of the outer surface portion of the battery member 70 as the active material separation surface 70a.

The moving table 30 can be moved and adjusted to an arbitrary position in the horizontal direction by a plurality of support shafts 31 extending, for example, in the horizontal direction. The plurality of support shafts 31 can be moved forward and rearward by an actuator (not shown). The actuator is controlled by a controller (not shown). The moving table 30 can be moved and adjusted to a desired position in the horizontal direction via the support shafts 31, thereby adjusting the position in the horizontal direction of the battery member 70 on the fixed stand 51 (the battery support part 50). By adjusting the position in the horizontal direction of the battery member 70 in this manner, the relative position in the horizontal direction to the liquid injection part 20a of the injection nozzle 20 is adjusted.

In addition, the moving table 30 can be moved and adjusted to any arbitrary position in the vertical direction (upward/downward direction) by a plurality of support shafts 33 extending, for example, in the vertical direction. The plurality of support shafts 33 can be moved forward and rearward by an actuator (not shown). The actuator is controlled by a controller (not shown). The moving table 30 can be moved and adjusted to a desired position in the vertical direction via the support shafts 33, thereby adjusting the position in the vertical direction of the battery member 70 on the fixed stand 51 (the battery support part 50). By adjusting the position in the vertical direction of the battery member 70 in this manner, the spacing distance between the liquid injection part 20a of the injection nozzle 20 and the active material separation surface 70a is adjusted.

The plurality of support shafts 33 extending in the vertical direction are each capable of being raised and lowered independently. By changing the lifting height of the support shaft 33 arranged on one side and the support shaft 33 arranged on the other side of the center axis of the approximately cylindrical moving table 30, the upper surface of the moving table 30 can be tilted with respect to the horizontal direction.

When the moving table 30 is not tilted, even after the separation processing of the active material is completed, the active material tends to remain on the upper surface of the moving table 30. For this reason, in order to remove any active material remaining on the upper surface of the moving table 30, a process of rinsing the active material with water or the like is carried out, but it becomes easier to remove the active material remaining on the upper surface of the moving table 30 by tilting the moving table 30.

The lower surface edge portion 34 of the moving table 30 has a shape corresponding to a shape of the contact portion 121 in the first reduced diameter section 120. When the moving table 30 moves vertically downward at approximately a center position of the body portion 110, the lower surface edge portion 34 of the moving table 30 comes into contact with the contact portion 121 of the first reduced diameter section 120. Accordingly, the inside of the container 10 is divided into a first space above the contact portion 121 and a second space below the contact portion 121.

When the liquid 22 is discharged from the inside of the container 10 through the first waste liquid section 170 and the second waste liquid section 180, the active material that has settled in the collecting filter 40 and the first reduced diameter section 120 may be stirred up within the liquid 22. In this case, there is a possibility that the stirred up active material will be discharged to the outside from the second waste liquid section 180 together with the liquid 22. However, in a state in which the liquid 22 is stored in the container 10 and the active material is precipitated near the collecting filter 40 in the first reduced diameter section 120 and in the collecting filter 40, when the lower surface edge portion 34 of the moving table 30 comes into contact with the contact portion 121 of the first reduced diameter section 120, the inside of the container 10 is divided into the above-mentioned first space and second space. For this reason, even if the active material is stirred up during the discharge of the liquid 22, the active material is prevented from being stirred up to the first space, and the active material is prevented from being discharged from the second waste liquid section 180. As a result, the decrease in the recovery rate of active material is suppressed.

A liquid surface detector 55 configured to detect a liquid surface height of the liquid 22 in the container 10 is installed at the lid 150 to which the injection nozzle 20 is attached. The liquid surface detector 55 is constituted by, for example, a laser displacement meter or the like. In the case of the laser displacement meter, the height of the liquid surface S is measured by emitting a laser downward. Information of the liquid surface height detected by the liquid surface detector 55 is output to a controller (not shown). Based on the input information, the controller adjusts the inflow volume of the liquid 22 into the container 10 and the emission amount of the liquid 22 outside the container 10, thereby accurately controlling the height of the liquid surface S of the liquid 22 inside the container 10.

In addition, the liquid 22 stored in the container 10 is adjusted such that the height of the liquid surface S is higher than the lower end of the liquid injection part 20a of the injection nozzle 20. The battery member 70 is disposed below the liquid injection part 20a of the injection nozzle 20 during separation processing of the active material. For this reason, the liquid surface S of the liquid 22 stored in the container 10 is higher than the upper surface of the battery member 70. That is, the battery member 70 is immersed under the liquid surface of the liquid 22 in the container 10. Then, the liquid injection part 20a of the injection nozzle 20 is also immersed under the liquid surface of the liquid 22 in the container 10. Accordingly, the high pressure liquid 22 injected from the liquid injection part 20a of the injection nozzle 20 is injected toward the battery member 70 in the liquid 22 in the container 10. At this time, since the high pressure liquid 22 injected from the liquid injection part 20a does not collide with the liquid surface S in the container 10, the energy of the injected high pressure liquid 22 is not significantly attenuated.

When the high pressure liquid 22 injected from the liquid injection part 20a of the injection nozzle 20 is injected vertically downward into the liquid 22 in the container 10, the jet stream of the high pressure liquid 22 draws the surrounding liquid 22 in the container 10 into the jet stream. As a result, the liquid 22 around the jet stream becomes under low pressure, generating a plurality of fine air bubbles. Thus, the generated plurality of air bubbles becomes a bubble cloud 65 that surrounds the jet stream and moves downward. The battery member 70 supported by the fixed stand 51 (the battery support part 50) is disposed below the jet stream of the high pressure liquid 22. At this time, the active material separation surface 70a of the battery member 70 is primarily exposed to the bubble cloud 65 surrounding the jet stream.

In FIG. 1, the active material separation surface 70a of the battery member 70 is disposed so as to be perpendicular to the injection direction of the high pressure liquid 22 injected from the injection nozzle 20. That is, the active material separation surface 70a is disposed in a horizontal posture facing upward. At this time, the active material separation surface 70a has no tilt angle with respect to a virtual plane v which is perpendicular to the injection direction of the high pressure liquid 22 injected from the injection nozzle 20 (it is parallel to the virtual plane v).

As described above, since the bubble cloud 65 exposed to the active material separation surface 70a is distributed over a wide range around the jet stream of the high pressure liquid 22, the separation of the wide range of active material can be achieved at once on the active material separation surface 70a. In addition, because the bubble cloud 65 is a gathering of fine air bubbles, it does not exert a large amount of stress on a core material of the battery member 70.

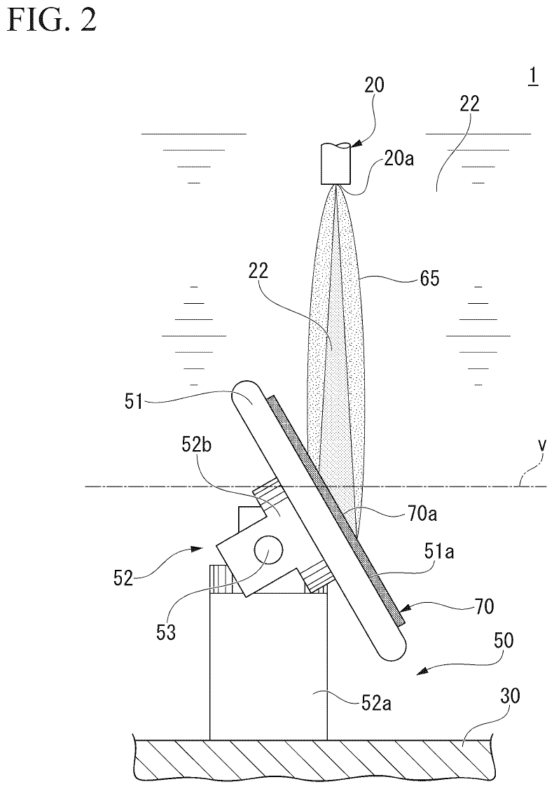

FIG. 2 to FIG. 4 are longitudinal cross-sectional views of a part of the separation device 1 showing a usage example different from FIG. 1. In FIG. 2 to FIG. 4, the part of FIG. 1 is enlarged.

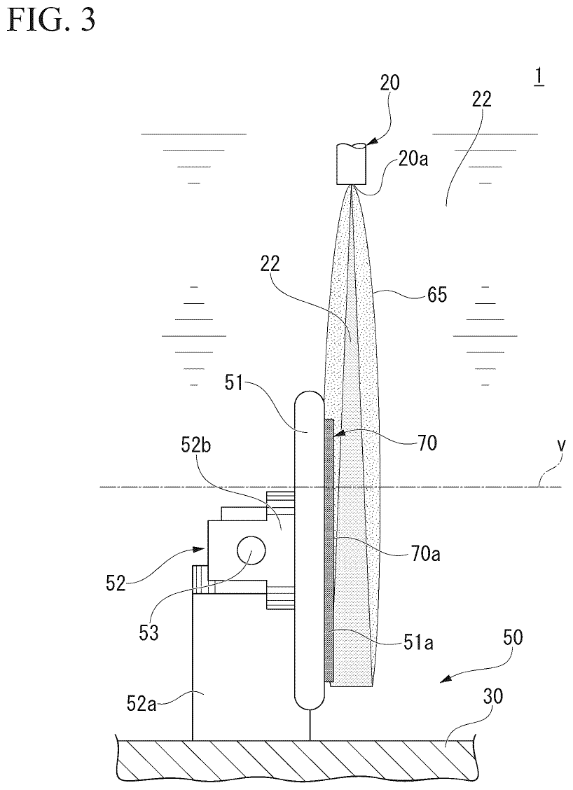

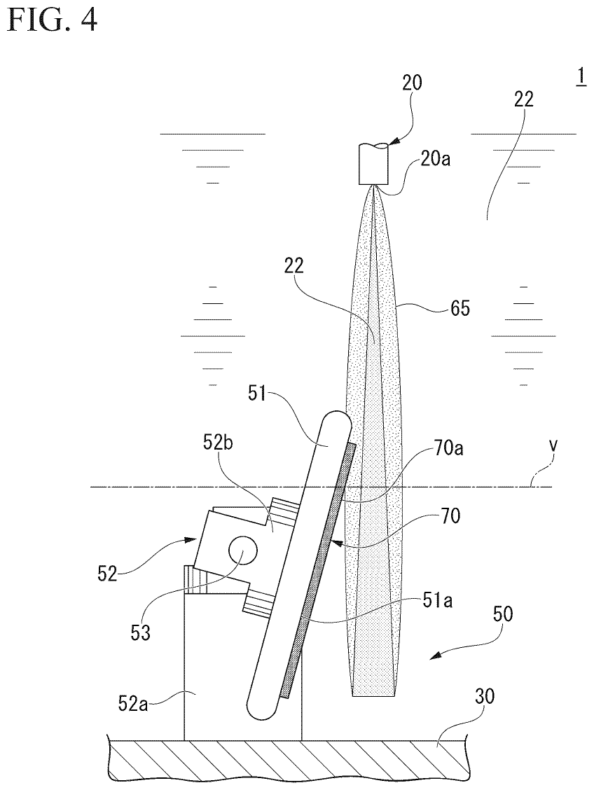

In the usage example of FIG. 1, the active material separation surface 70a of the battery member 70 has no tilt angle with respect to the virtual plane v (tilt angle) 0°. On the other hand, in the usage example of FIG. 2, by adjustment using the tilt angle adjusting mechanism 52, the active material separation surface 70a of the battery member 70 is set to have a tilt angle of approximately 60° with respect to the virtual plane v described above. In addition, in the usage example of FIG. 3 and the usage example of FIG. 4, the active material separation surfaces 70a of the battery member 70 are tilted at angles of approximately 90° and 105° with respect to the virtual plane v, respectively.

In the usage example of FIG. 2, since the battery member 70 is held so that the active material separation surface 70a has a tilt angle of approximately 60° with respect to the virtual plane v, the jet stream of the high pressure liquid 22 does not hit the active material separation surface 70a at a right angle, and the bubble cloud 65 around the jet stream is exposed over a wider area of the active material separation surface 70a at one time.

In addition, in the usage example of FIG. 3, since the active material separation surface 70a is approximately parallel to the jet stream of the high pressure liquid 22, it becomes difficult for the jet stream of the high pressure liquid 22 to directly hit the active material separation surface 70a, and almost only the surrounding bubble cloud 65 exposes over a wide range of the active material separation surface 70a.

In addition, in the usage example of FIG. 4, since the active material separation surface 70a is oriented so as to face diagonally downward relative to the jet stream of the high pressure liquid 22, the jet stream of the high pressure liquid 22 does not directly hit the active material separation surface 70a, and the bubble cloud 65, which spreads out widely downward, is able to be exposed at a wider range of the active material separation surface 70a at once.

Further, when the active material separation surface 70a of the battery member 70 is disposed with a tilt angle relative to the virtual plane v described above, taking into consideration improving the separation efficiency of the active material and reducing stress on the battery member 70, it is desirable for the tilt angle θ to be in the range of 60° ≤0≤105°.

The battery member 70 that is a processing target of the separation device 1 contains, for example, a positive electrode active material having Li, and a solid electrolyte material. The battery member 70 may have at least one of a conductive material and a negative electrode active material.

The positive electrode active material is not particularly limited but may contain, for example, Li. The positive electrode active material does not normally dissolve in the liquid 22. As the positive electrode active material, for example, a layered positive electrode active material, a spinel type positive electrode active material, an olivine type positive electrode active material, or the like, can be exemplified. As the layered positive electrode active material, for example, LiCoO₂, LiNiO₂, LiCo₁/3Ni₁/3Mn₁/3O₂, LiVO₂, LiCrO₂, or the like, can be exemplified. As the spinel type positive electrode active material, for example, LiMn₂O₄, LiCoMnO₄, Li₂NiMn₃O₈, LiNi_{0.5}Mn_{1.5}O₄, or the like, can be exemplified. As the olivine type positive electrode active material, for example, LiCoPO₄, LiMnPO₄, LiFePO₄, or the like, can be exemplified.

The solid electrolyte material contains components that dissolve in the liquid 22. The solid electrolyte material contains, for example, Li and S. It is preferable that the solid electrolyte material does not contain any components that are insoluble in the liquid 22. If the solid electrolyte material consists only of components that dissolve in the liquid 22, the separation processing between the insoluble component and the positive electrode active material is not necessary, making it easy to recover the positive electrode active material. As the solid electrolyte material containing Li and S, for example, those having Li, S and a third component can be exemplified. The third component can be, for example, at least one selected from the group consisting of P, Ge, B, Si, I, Al, Ga and As. The sulfide solid electrolyte material may be a compound containing Li₂S and a sulfide other than Li₂S.

As the negative electrode active material, for example, a metal active material and a carbon active material can be exemplified. As the metal active material, for example, In, Al, Si, Sn, and the like, can be exemplified. As the carbon active material, for example, mesocarbon microbeads, highly oriented graphite, hard carbon, soft carbon, or the like, can be exemplified.

As the conductive material for example, acetylene black, carbon fiber, or the like, can be exemplified.

In addition, the battery member 70 may have a current collecting foil. The current collecting foil is, for example, an aluminum foil attached to the positive electrode of the battery member 70 or a copper foil attached to the negative electrode of the battery member 70.

In addition, the controller that controls the devices placed inside and outside the container 10 is realized by hardware including, for example, a calculation unit such as a CPU, main storage devices such as a ROM (Read only memory) or a RAM (Random access memory), and auxiliary storage devices such as a hard disk and flash memory. The controller may be configured by a single piece of hardware, or may be configured by a plurality of pieces of hardware. Further, the controller may be realized by an embedded system.

So far, the configuration of the separation device 1 of the embodiment has been described. Next, an example of an active material separation method from the battery member 70 using the separation device 1 of this embodiment will be described.

First, in a state in which the first opening/closing valve 171 and the second opening/closing valve 181 are closed, the battery member 70 is disposed on the upper surface of the fixed stand 51 of the battery support part 50. Next, the liquid 22 is introduced into the container 10 from the injection nozzle 20 above. At this time, a flow rate of the liquid 22 introduced into the container 10 is controlled by the controller so that the battery member 70 and the liquid injection part 20a of the injection nozzle 20 are immersed in the liquid 22 at a specified liquid surface height. Specifically, while introducing the liquid 22 stored inside the container 10, the height of the liquid surface S is measured by the liquid surface detector 55. The controller receives information on the liquid surface height from the liquid surface detector 55 and adjusts the amount of the liquid 22 introduced so that the liquid surface S in the container reaches a specified height.

In addition, at any time before or after the introduction of the liquid 22 described above, positions in the horizontal and vertical directions of the moving table 30 of the battery support part 50 are adjusted to appropriate positions, and the angle at which the active material separation surface 70a of the battery member 70 faces is also appropriately adjusted by the tilt angle adjusting mechanism 52.

Next, the high pressure liquid 22 is injected from the liquid injection part 20a of the injection nozzle 20 immersed in the liquid 22 in the container 10 toward the active material separation surface 70a of the battery member 70. Accordingly, the above-mentioned bubble cloud 65 is generated around the jet stream of the liquid 22 from the liquid injection part 20a, and the bubble cloud 65 is exposed to the active material separation surface 70a. The active material on the active material separation surface 70a is separated from the active material separation surface 70a by exposure of the bubble cloud 65 and falls downward in the liquid 22.

The active material separated from the active material separation surface 70a falls downward and is collected by the collecting filter 40. Further, a portion of the liquid 22 in the container 10, which is increased by the injection of the liquid 22 from the injection nozzle 20, is appropriately discharged to the outside through the second waste liquid section 180 by the opening action of the opening/closing valve 181.

After the above-mentioned exposure of the bubble cloud 65 has been performed at one location on the active material separation surface 70a, the position of the battery member 70 is appropriately moved through the battery support part 50, and a similar exposure of the bubble cloud 65 is performed at the moved position. Exposure of the bubble cloud 65 is repeated until the active material is ionized from almost the entire area of the battery member 70.

When the above-mentioned separation processing of the active material from the battery member 70 is completed, the injection of the high pressure liquid 22 from the injection nozzle 20 is stopped and it is made still. This still allows the precipitation of the active material to proceed.

After the above-mentioned still, the moving table 30 is lowered so that the contact portion 121 of the first reduced diameter section 120 comes into contact with the lower surface edge portion 34 of the moving table 30. Accordingly, the inside of the container 10 is divided into the first space below the contact portion 121 and the second space above the contact portion 121.

After that, the first opening/closing valve 171 and the second opening/closing valve 181 are opened, and the liquid 22 stored in the container 10 is discharged to the outside of the container 10. At this time, the first waste liquid section 170 discharges the liquid 22 stored in the first space, and the second waste liquid section 180 discharges the liquid 22 stored in the second space. Accordingly, the active material is collected in the collecting filter 40.

If necessary, the moving table 30 is moved upward to release the contact between the contact portion 121 and the lower surface edge portion 34 of the moving table 30, and the upper surface of the moving table 30 is tilted by raising and lowering the support shafts 33 extending in the vertical direction. After the moving table 30 is tilted, the high pressure liquid 22 is injected from the injection nozzle 20 toward the moving table 30. Accordingly, the active material remaining on the moving table 30 is removed from the moving table 30, and the removed active material is collected in the collecting filter 40.

As described above, the separation device 1 of the embodiment is disposed at a position where the liquid injection part 20a of the injection nozzle 20 is immersed in the liquid 22 of the container 10. When the high pressure liquid 22 is injected from the liquid injection part 20a, the bubble cloud 65 is generated around the jet stream, and the bubble cloud 65 is exposed to the active material separation surface 70a of the battery member 70. Accordingly, when the separation device 1 of the embodiment is used, the bubble cloud 65 can efficiently separate the active material from the active material separation surface 70a.

In addition, in the separation device 1 of the embodiment, since the high pressure liquid 22 injected from the injection nozzle 20 does not collide with the liquid surface S in the container 10, unnecessary energy loss is suppressed. Further, the bubble cloud 65 occurs over a wide range around the jet stream of the liquid 22, so that the active material can be separated over a wide range on the active material separation surface 70a at one time.

In addition, the separation device 1 of this embodiment separates the active material from the battery member 70 by exposing the active material separation surface 70a to the bubble cloud 65, thereby suppressing deformation of the substrate of the battery member 70 caused by the high pressure liquid 22 directly hitting the battery member 70. That is, in the separation device 1 of the embodiment, the bubble cloud 65 can be exposed over a wide range on the active material separation surface 70a without significantly increasing a discharge pressure of the liquid 22 injected from the injection nozzle 20. For this reason, even if the liquid 22 injected from the injection nozzle 20 collides with the active material separation surface 70a, deformation of the substrate of the battery member 70 is unlikely to occur.

Accordingly, when the separation device 1 of the embodiment is employed, the active material can be efficiently separated from the battery member 70 without excessive stress caused by the jet stream of the liquid 22 acting on the battery member 70.

In addition, in the separation device 1 of this embodiment, as in each of the usage examples shown in FIGS. 2 to 4, the active material separation surface 70a of the battery member 70 can be given a tilt angle (excluding) 0° with respect to the virtual plane v that is perpendicular to the injection direction of the liquid 22 from the injection nozzle 20. When the active material separation surface 70a of the battery member 70 has a tilt angle in this manner, the bubble cloud 65 generated by the injection of the high pressure liquid 22 from the injection nozzle 20 hits a wider range on the active material separation surface 70a. Accordingly, the separation efficiency of the active material from the battery member 70 can be further increased.

In addition, even when the high pressure liquid 22 injected from the injection nozzle 20 directly collides with the battery member 70, the active material separation surface 70a is tilted with respect to the injection direction of the liquid 22, and thereby, the impact acting on the core material of the battery member 70 can be mitigated.

In addition, the battery support part 50 of the separation device 1 of the embodiment is structured so that the tilt angle of the active material separation surface 70a with respect to the virtual plane v, which is perpendicular to the injection direction of the liquid 22 from the injection nozzle 20, can be adjusted to an arbitrary angle. For this reason, the posture of the battery member 70 can be adjusted to the optimal tilt angle for each battery member 70. Accordingly, the separation device 1 equipped with the battery support part 50 of the embodiment can further improve the separation efficiency of the active material from the battery member 70.

As shown in FIG. 3, when the tilt angle of the active material separation surface 70a with respect to the virtual plane v is set to 90° in the separation device 1 of this embodiment, only the bubble cloud 65 generated around the jet stream of the high pressure liquid 22 can be efficiently exposed onto the active material separation surface 70a. For this reason, even if the injection pressure of the liquid 22 injected from the injection nozzle 20 is increased, it becomes difficult for the jet stream of the liquid 22 to directly hit the battery member 70. Accordingly, when the configuration is employed, this enables efficient separation of the active material by the bubble cloud 65 while suppressing deformation of the substrate of the battery member 70.

In addition, the separation device 1 of the embodiment has the moving table 30 (the battery support part 50) that supports the battery member 70, which is movable in the horizontal direction and the vertical direction. For this reason, the position of the battery member 70 can be adjusted so that the bubble cloud 65 generated around the jet stream of the liquid 22 is directed to the appropriate location on the battery member 70. Accordingly, when the configuration is employed, the separation efficiency of the active material from the battery member 70 can be further increased.

An active material separation method employed in the embodiment includes injecting the high pressure liquid 22 in the liquid 22 to the battery member 70, and separating the active material from the battery member 70 using the bubble cloud 65 generated around the jet stream of the high pressure liquid 22. For this reason, when the method is employed, it becomes possible to efficiently separate the active material over a wide range of the battery member 70, and it also becomes possible to suppress deformation of the substrate of the battery member 70.

### Second Embodiment

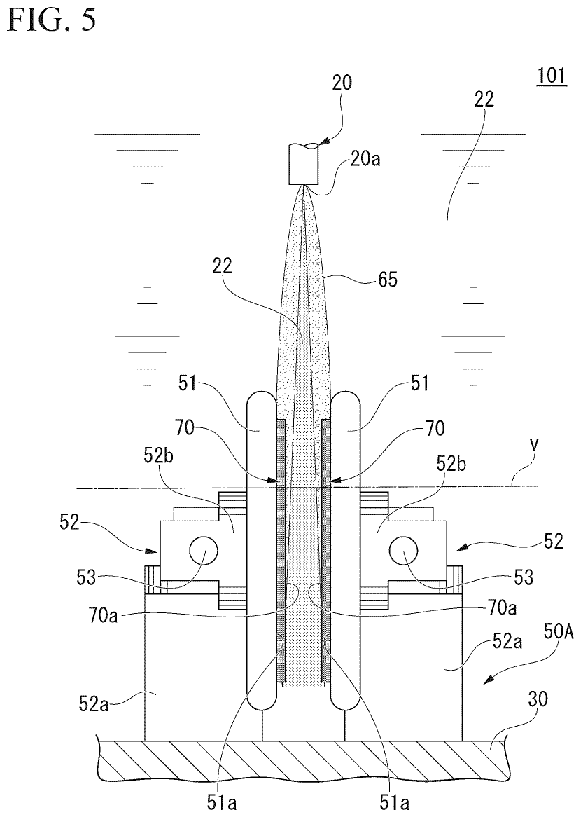

FIG. 5 is a longitudinal cross-sectional view of a part of an active material separation device 101 (hereinafter, simply referred to as “the separation device 101”) of the embodiment.

The separation device 101 has a basic configuration that is almost the same as that of the first embodiment described above, but a configuration of a battery support part 50A that supports a battery member 70 differs from that of the first embodiment. The battery support part 50A of this embodiment is provided with a pair of fixed stands 51 attached to the upper surface of the moving table 30.

The pair of fixed stands 51 are installed on the moving table 30 so that the placing surfaces 51a that fix the battery members 70 face each other. Each of the fixed stands 51 is installed on the moving table 30 so that the placing surface 51a and the active material separation surface 70a of the battery member 70 fixed to the placing surface 51a have a tilt angle of 90° with respect to the virtual plane v (a virtual plane perpendicular to the injection direction of the high pressure liquid 22 injected from the injection nozzle 20). Then, a predetermined gap is maintained between the active material separation surface 70a of the battery member 70 fixed to one of the fixed stands 51 and the active material separation surface 70a of the battery member 70 fixed to the other fixed stand 51. The jet stream of the high pressure liquid 22 from the injection nozzle 20 is injected toward the gap between the active material separation surfaces 70a of two battery members 70 arranged facing each other. At this time, the bubble cloud 65 generated around the jet stream of the liquid 22 simultaneously exposes the active material separation surfaces 70a of the two battery members 70.

In the separation device 101 of the embodiment, the active material separation surfaces 70a of the two battery members 70 supported by each of the fixed stands 51 are disposed around the jet stream of the liquid 22, so that the bubble cloud 65 generated around the jet stream of the liquid 22 can expose simultaneously the active material separation surfaces 70a of the two battery members 70. For this reason, when the configuration is employed, the active material can be efficiently separated from the plurality of battery members 70.

In particular, in the separation device 101 of the embodiment, since the active material separation surfaces 70a of the two battery members 70 are disposed to face each other across the jet stream of the high pressure liquid 22, even if the area (outer shape) of the active material separation surface 70a of each battery member 70 is large, the active material separation surfaces 70a of the pair of battery members 70 can be disposed sufficiently close to the bubble cloud 65 that is generated as the liquid 22 is injected. Accordingly, the active material can be efficiently separated from the two battery members 70.

However, it is also possible to provide three or more fixed stands 51 to which the battery members 70 are fixed, and to dispose the active material separation surface 70a of the battery members 70 fixed to each fixed stand 51 in the periphery of the jet stream of the liquid 22 from the injection nozzle 20. In this case, if the area (outer shape) of the active material separation surface 70a of each battery member 70 is small, the active material separation surface 70a can be brought sufficiently close to the bubble cloud 65 without causing interference between the battery members 70. For this reason, it is possible to efficiently separate active materials from a plurality of (three or more) battery members 70.

Further, the present invention is not limited to the above-mentioned embodiments, and various design modifications are possible without departing from the scope of the present invention. For example, in the above-mentioned embodiment, although the battery support parts 50 and 50A disposed within the container 10 is supported by the plurality of support shafts 31 and 33 and is movable in the horizontal and vertical directions, a mechanism for moving the battery support parts 50 and 50A is not limited to this. The moving mechanism may be, for example, a mechanism using a ball screw or a rack and pinion.

In addition, in the above-mentioned embodiment, although the injection nozzle 20 is attached to the lid 150 of the container 10, the injection nozzle 20 may be attached to a location other than the lid 150. The injection nozzle 20 may be fixed to the body portion 110 of the container, for example, via a dedicated bracket.

In addition, in the above-mentioned embodiment, although the injection direction of the high pressure liquid 22 from the injection nozzle 20 is set vertically downward, the injection direction of the high pressure liquid 22 may be in a direction other than vertically downward. As long as the liquid injection part 20a of the injection nozzle 20 is immersed in the liquid 22 in the container 10, the injection direction may be tilted with respect to the vertical direction. However, from the viewpoint of allowing the active material separated from the battery member 70 to fall quickly below the liquid 22, it is desirable to set the injection direction of the liquid 22 vertically downward, as in the above-mentioned embodiment.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. An active material separation device configured to separate an active material from a battery member containing the active material, the active material separation device comprising:
a container in which a liquid is stored;
a battery support part that is disposed in the container and that is configured to support the battery member; and
an injection nozzle configured to inject a high pressure liquid with respect to an active material separation surface of the battery member immersed in the liquid in the container,
wherein the injection nozzle is disposed at a position where a liquid injection part configured to inject the high pressure liquid is immersed in the liquid in the container.

2. The active material separation device according to claim 1, wherein the battery support part supports the battery member such that the active material separation surface has a tilt angle with respect to a virtual plane perpendicular to an injection direction of the high pressure liquid.

3. The active material separation device according to claim 2, wherein the tilt angle of the battery support part with respect to the virtual plane is adjustable.

4. The active material separation device according to claim 2, wherein the battery support part supports the battery member such that the tilt angle with respect to the virtual plane is 90°.

5. The active material separation device according to claim 4, wherein the battery support part supports the plurality of battery members, and
the plurality of battery members are arranged such that each of the active material separation surfaces is disposed around a jet stream of the high pressure liquid.

6. The active material separation device according to claim 4, wherein the battery support part supports the pair of battery members, and
the pair of battery members are arranged such that the active material separation surfaces face each other while having the jet stream of the high pressure liquid between the pair of battery members.

7. The active material separation device according to claim 1, wherein the battery support part is movable in a horizontal direction and a vertical direction.

8. An active material separation method of separating an active material from a battery member containing the active material, the active material separation method comprising:
injecting a high pressure liquid in a liquid with respect to the battery member; and
separating the active material using a bubble cloud generated around a jet stream of the high pressure liquid.
